(19) United States
(12) Patent Application Publication
(10) Pub. No.: US 2024/0114285 A1
(43) Pub. Date: Apr. 4, 2024

(54) EAR-WORN HEARING DEVICE WITH REMOVABLE SPEAKER

(71) Applicant: KNOWLES ELECTRONICS, LLC, ITASCA, IL (US)

(72) Inventors: CHRISTOPHER MONTI, ELGIN, IL (US); CHARLES KING, OAK PARK, IL (US); MOHAMMAD MOHAMMADI, ROLLING MEADOWS, IL (US); DONALD VERGHESE JACOB, CHICAGO, IL (US); MATTHEW MANLEY, CRYSTAL LAKE, IL (US); YAHUI ZHANG, SCHAUMBURG, IL (US); SHEHAB ALBAHRI, HANOVER PARK, IL (US)

(21) Appl. No.: 18/448,943

(22) Filed: Aug. 13, 2023

Related U.S. Application Data
(60) Provisional application No. 63/378,001, filed on Sep. 30, 2022.

(51) Int. Cl. H04R 1/10; H04R 1/28; H04R 25/00

(52) U.S. Cl. CPC H04R 1/1075; H04R 1/288; H04R 25/604

(57) ABSTRACT

An ear-worn hearing device comprises a housing comprising an end portion configured for at least partial insertion into a user's ear, the housing comprises an opening at the end portion. A removable acoustic transducer assembly is disposed in the opening at the end portion. The transducer assembly is configured for removal from the end portion of the ear-worn hearing device housing. The transducer assembly comprises an acoustic transducer, a support structure mechanically coupled to the acoustic transducer, the open portion of the acoustic transducer acoustically coupled with an opening of the support structure; and a releasable retention structure configured to removably retain the transducer assembly in a cavity of the ear-worn hearing device housing. In some implementations a vibration isolation structure isolates the acoustic transceiver from vibration. In certain implementations, the transducer assembly includes an extraction feature that allows extraction from the end portion of the ear-worn device.

### CROSS REFERENCE TO RELATED APPLICATION

This is a non-provisional application for patent entitled to a filing date and claiming the benefit of earlier-filed U.S. Provisional Patent Application No. 63/378,001, filed Sep. 30, 2022 and entitled, “EAR-WORN HEARING DEVICE WITH REMOVABLE SPEAKER”, which is herein incorporated by reference in its entirety.

### FIELD OF THE DISCLOSURE

The present disclosure relates generally to hearing devices and more particularly to ear-worn hearing devices comprising an acoustic transducer removably assembled with a housing having a portion placed on or at least partially into a user's ear, and to acoustic transducer assemblies for removable assembly with ear-worn hearing devices.

### BACKGROUND

Some ear-worn hearing devices are configured for wear at least partially in the user's ear. Such hearing devices include In-the-Ear (ITE), In-the-Canal (ITC), and Completely-in-the-Canal (CIC) hearing aids and in-ear monitors favored by musicians and audiophiles. These and other hearing devices generally comprise an acoustic transducer integrated in a moisture-sealed housing that is often custom-made for the user's unique anatomy. The transducer can be a dynamic speaker or a balanced armature receiver (also referred to herein as a “receiver”). Depending on the type of hearing device, the housing may also comprise one or more batteries, one or more microphones and an electrical circuit for converting sensed environmental sounds into amplified electrical audio signals applied to the speaker or receiver. The close proximity of these and other hearing devices to the user's ear canal exposes the receiver to earwax, also known as cerumen, and wax vapor that can infiltrate and degrade the sound produced by the transducer, even in the presence of a wax guard. Replacement of a damaged receiver usually requires returning the hearing device to the manufacturer for service since the housing and acoustic transducer are assembled with glue and solder. But service by the manufacturer may not be possible and when it is possible it is a laborious, lengthy and costly task that can deprive the user of the hearing device for days or weeks. Thus, there is an ongoing need for improvements in ear-worn hearing devices comprising integrated acoustic transducers.

### BRIEF DESCRIPTION OF THE DRAWINGS

The objects, features and advantages of the present disclosure will become more fully apparent from the following detailed description and the appended claims considered in conjunction with the accompanying drawings. The drawings depict only representative embodiments and are therefore not considered to limit the scope of the disclosure.

FIG. 1 is a sectional view of an end portion of an ear-worn hearing device.

FIG. 2 is a sectional view of an acoustic transducer with a first configuration.

FIG. 3 is a sectional view of an acoustic transducer with a second configuration.

FIG. 4 is a perspective view of an ear-worn hearing device housing and an acoustic transducer assembly that is removably attachable with the ear-worn device housing.

FIG. 5 is a sectional view of the acoustic transducer assembly of FIG. 4 removably retained is an end portion of the ear-worn hearing device housing of FIG. 4.

FIG. 6 is a sectional view with a 90 degree rotation compared to the sectional view of FIG. 5.

FIG. 7 is an exploded view of the acoustic transducer assembly of FIG. 4.

FIG. 8 is a perspective view of another example of an acoustic transducer assembly and an end portion of an ear-worn hearing device housing wherein the acoustic transducer assembly is electrically disconnected from an electric circuit and mechanically removed from an end portion of the ear-worn hearing device housing.

FIG. 9 is an exploded view of the acoustic transducer assembly of FIG. 8.

FIG. 10 is a sectional view of another example of an of an acoustic transducer assembly removably connected in an end portion of an ear-worn hearing device housing.

FIG. 11 is a perspective view of the acoustic transducer shown in FIG. 10.

FIG. 12 is a perspective view of the acoustic transducer assembly and an end portion of an ear-worn hearing device housing shown in FIG. 10.

FIG. 13 is a perspective view of another example of an acoustic transducer assembly and an end portion of an ear-worn hearing device housing.

FIG. 14 is a perspective view of the acoustic transducer assembly shown in FIG. 13.

FIG. 15 is a sectional view of the acoustic transducer assembly of FIG. 13 removably connected in the end portion of the ear-worn hearing device housing.

FIG. 16 is a sectional view of another example of an acoustic transducer assembly removably connected in an end portion of an ear-worn hearing device housing.

FIG. 17 is a perspective view of the acoustic transducer assembly of FIG. 16 and a portion of an acoustic transducer assembly removal device to remove the acoustic transducer assembly from the end portion of the ear-worn hearing device housing.

FIG. 18 diagrammatically illustrates the removal device in an extraction feature of the acoustic transducer assembly and also rotated 90 degrees for extraction.

FIG. 19 is a sectional view of another example of an of an acoustic transducer assembly removably connected in an end portion of an ear-worn hearing device housing.

FIG. 20 is an exploded view of the acoustic transducer assembly of FIG. 19.

FIG. 21 is an exploded view of the acoustic transducer assembly of FIG. 19 and an end portion of an ear-worn hearing device housing.

Those of ordinary skill in the art will appreciate that the figures are illustrated for simplicity and clarity and therefore may not be drawn to scale and may not include well-known features, that the order of occurrence of actions or steps may be different than the order described or that some or all of the actions or steps may be performed concurrently unless specified otherwise, and that the terms and expressions used herein have meanings understood by those of ordinary skill in the art except where different meanings are attributed to them herein.

### DETAILED DESCRIPTION

The present disclosure relates generally to hearing devices comprising an acoustic transducer removably disposed and retained in an ear-worn housing of the hearing device, and to acoustic transducer assemblies for removable assembly with ear-worn hearing devices. Such hearing devices include In-the-Ear (ITE, Full shell), Half-Shell (HS), In-the-Canal (ITC), and Completely-in-the-Canal (CIC) hearing aids, Invisible-in-the-canal (ITC), Speaker-in-Concha (SIC), hearing devices that fit at least partially into the user's concha, ear-worn monitors favored by musicians and audiophiles, among other hearing devices that may require removal of the acoustic transducer for service or replacement. These and other hearing devices generally comprise an ear-worn housing having a portion that extends at least partially into the user's ear (e.g., into the concha or ear canal) and are configured to removably retain an acoustic transducer assembly.

In some implementations, an ear-worn hearing device comprises a housing comprising an end portion configured for at least partial insertion into a user's ear, the housing comprises an opening at the end portion. An electrical circuit is disposed in the housing and a transducer assembly is disposed in the housing. The transducer assembly is configured for removal from the end portion of the ear-worn hearing device housing. The transducer assembly comprises an acoustic transducer comprising a motor-actuated diaphragm and an open portion from which sound is emitted, a support structure mechanically coupled to the acoustic transducer, the open portion of the acoustic transducer acoustically coupled with an opening of the support structure, and a releasable retention structure configured to removably retain the transducer assembly in a cavity of an ear-worn hearing device housing when the transducer assembly is assembled with the ear-worn hearing device housing.

Hearing aids and other hearing devices that amplify sound increase the amplitude of environmental sounds by adding gain to the signal received by one or more microphones. The signal produced by the microphone has multiple sources beyond the sensed environmental sounds including sound produced by the speaker and leaking out of the ear, sound produced by vibration motion of the hearing device, and intrinsic vibration sensitivity of the microphone. These other sources of signal can limit the amount of gain possible in an amplified hearing device by producing feedback.

By decoupling the speaker from the hearing device the vibration-induced sources of feedback signal may be decreased. Decoupling typically means putting the speaker on a soft isolation structure that allows the BA to move more freely within the hearing device housing. As such, the forces generated by the motion of components inside the speaker are reduced and so is the motion of the housing of the hearing device and the microphones mounted inside the hearing device. With reduced motion of the housing and the microphones the sources of feedback are reduced and more gain can be applied to the hearing device.

Portions of the vibration isolation system are part of the ear-worn device housing and other portions are part of the acoustic transducer assembly. In certain implementations, the vibration isolation system is included in the acoustic transducer assembly. In some implementations, a vibration isolator couples the acoustic transducer to the support structure. In certain implementations, a vibration isolator couples the acoustic transducer to the ear-worn device housing. In some implementations, the vibration isolator includes an elastic gasket on an exterior of the acoustic transducer.

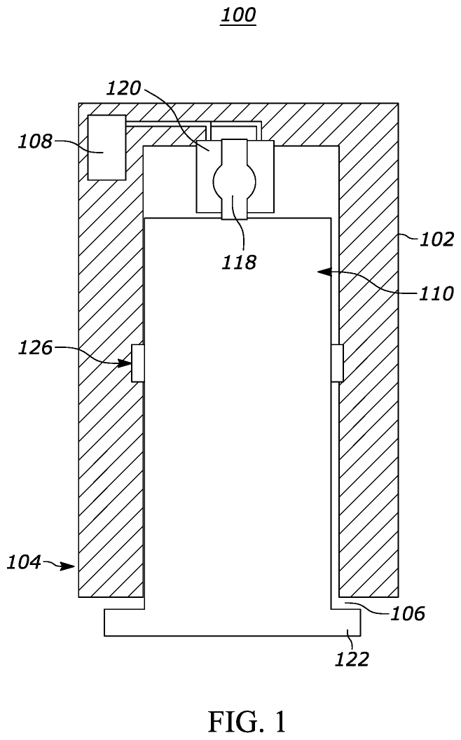

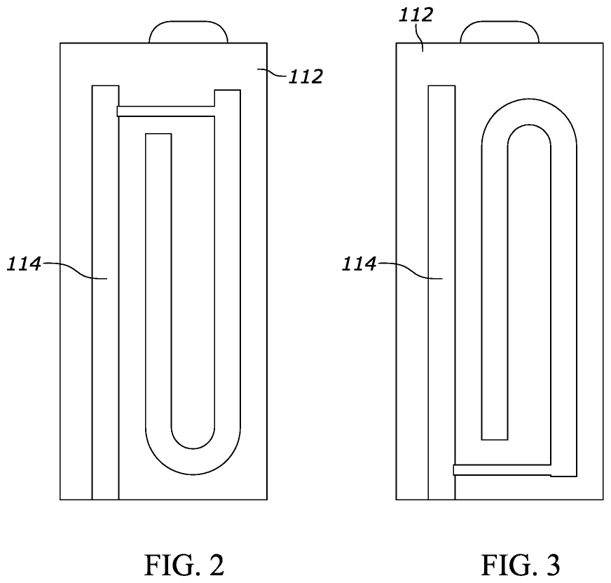

Referring to FIGS. 1-3, a housing 104 of an ear-worn hearing device 100 has an opening 106 in an end portion 102. An electrical circuit 108 is disposed in the housing and provides various hearing device functions including sound amplification, among others. The electrical circuit 108 includes electrical wires connected to contacts electrically connectable to an acoustic transducer assembly 110 removably disposed in the housing 104. The transducer assembly minimally comprises an acoustic transducer that can be embodied as one or more receivers or dynamic speakers or a combination thereof. In FIGS. 2 and 3, the acoustic transducer comprises a motor-actuated diaphragm 114 that emits sound from the transducer. In FIG. 1, the acoustic transducer assembly includes electrical contacts, such as pins 118, removably connectable to corresponding contacts, such as sockets 120, of the housing, thereby electrically connecting the transducer to the electrical circuit. The contacts of the transducer assembly can be contacts on the transducer or secondary contacts of the transducer assembly electrically connected to the transducer contacts. Friction/force based mechanical electrical connections systems eliminate the need for de-soldering and re-soldering of the electrical connections when removing or replacing acoustic transducer.

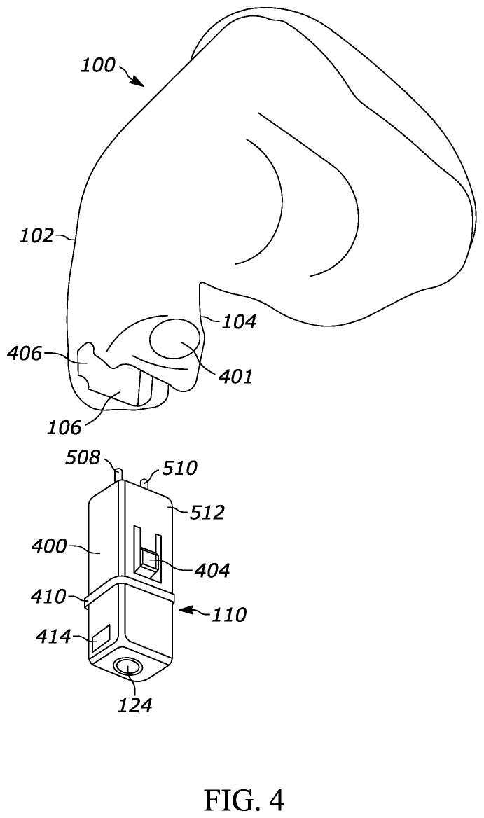

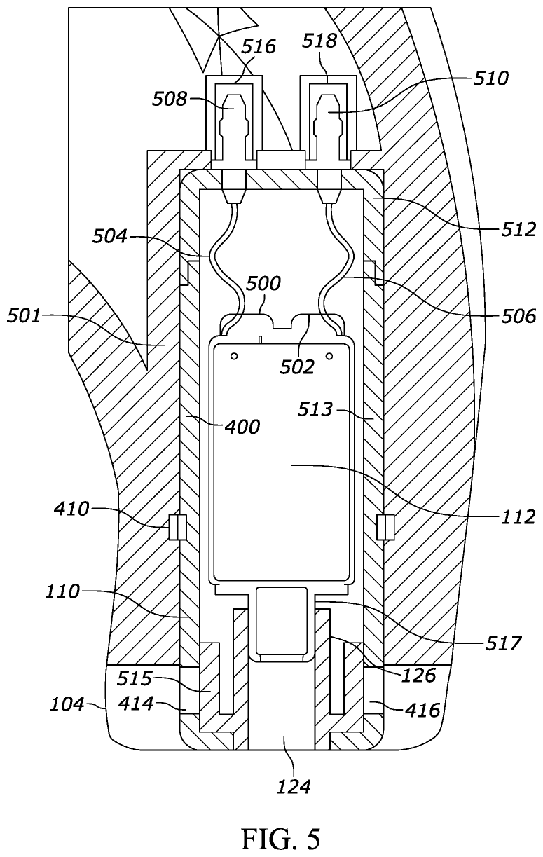

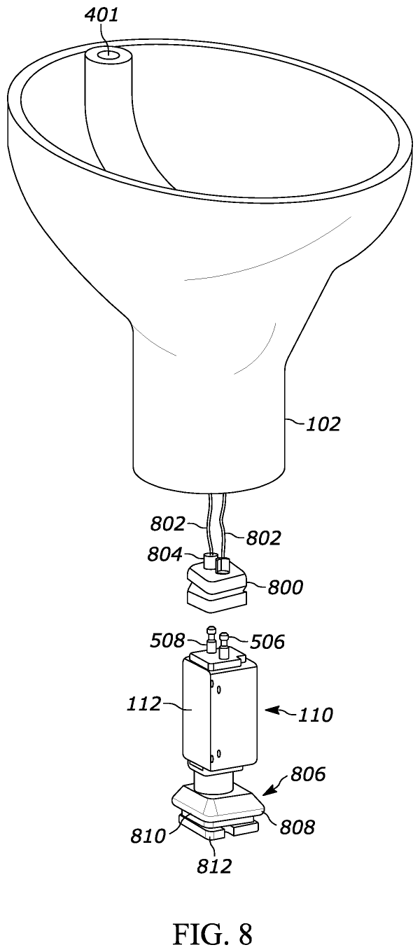

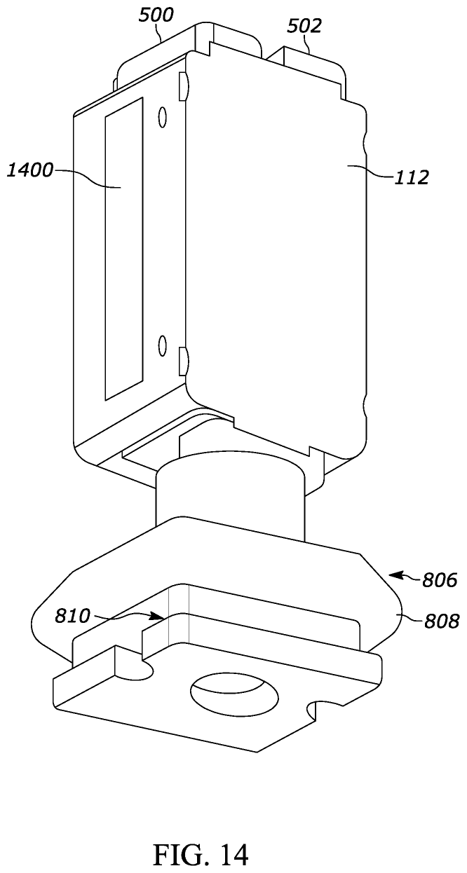

The acoustic transducer assembly includes retention structure removably coupled mechanically to the ear-worn device housing. In FIG. 1, the retention structure comprises connector pins 118 of the acoustic transducer assembly connectable to electrical contacts configured as pin sockets 120 of the housing. The pins of the transducer are frictionally retained by the pin sockets of the housing, thereby mechanically coupling the transducer to the housing and electrically connecting the transducer to the electrical circuit. The transducer assembly can be removed from the housing by a pulling force sufficient to separate the pins from the sockets. Alternative electrical connector pin and socket type retention structures are shown in FIGS. 5, 8, 10 and 16. Non-conductive retention structures are shown in FIG. 4 as described further herein. The transducer assembly can also be retained in the housing by elastic barbs on a vibration isolator as shown in FIGS. 8, 14 and 15.

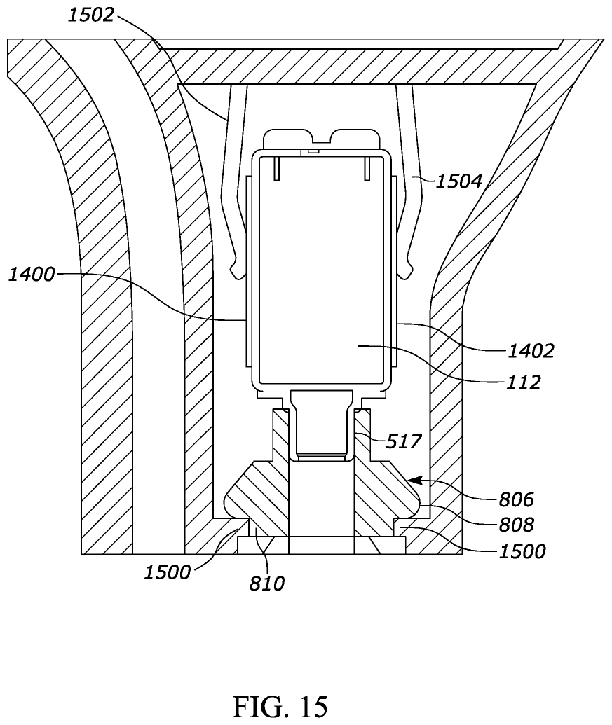

In some ear-worn hearing devices, the acoustic transducer assembly comprises a vibration isolator. In some implementations, the vibration isolator couples the acoustic transducer to a support structure of the transducer assembly. In other implementations, the vibration isolator is a compliant electrical connection between the transducer assembly and the device housing. Such a connection can be formed by spring pins in the device housing and rigid pins on the transducer housing. In FIGS. 5, 8, 10, 13, 16 and 20, the vibration isolator comprises one or more elastic boots between the transducer and a housing in which the transducer is retained. In FIG. 15, spring fingers (also used as a retention structure) can provide vibration isolation. In FIG. 1, a elastic seal 126 (also used as a debris barrier) located between the vibration isolation structure and an inner surface of the housing can provide vibration isolation. The elastic seal can be seated in a groove on the transducer assembly or on the inner surface of the housing, or on both. In FIG. 4, a gasket 410 (also used as a debris barrier) between the acoustic transducer assembly and the ear-worn device housing can provide vibration isolation. Compliant electrical wires, such as litz wires, electrically coupling the acoustic transducer to the ear-worn hearing device can also provide vibration isolation as shown in FIGS. 5, 8, 10 and 16.

In some implementations, the transducer assembly further comprises an extraction feature on the support structure, wherein the transducer assembly can be removed from the ear-worn hearing device housing via the extraction feature. The transducer assembly can also comprise a vibration isolation member or system that isolates the acoustic transducer from vibration.

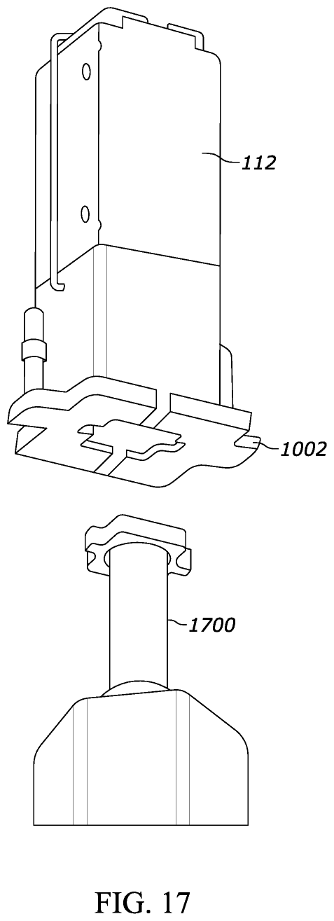

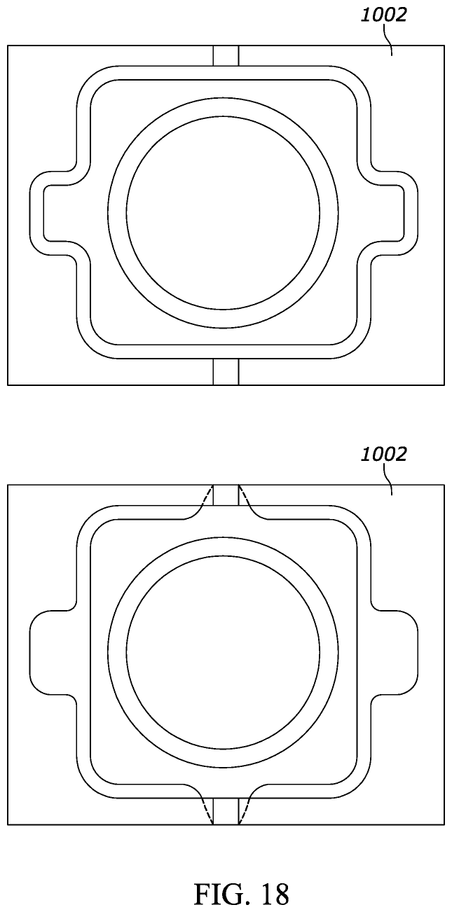

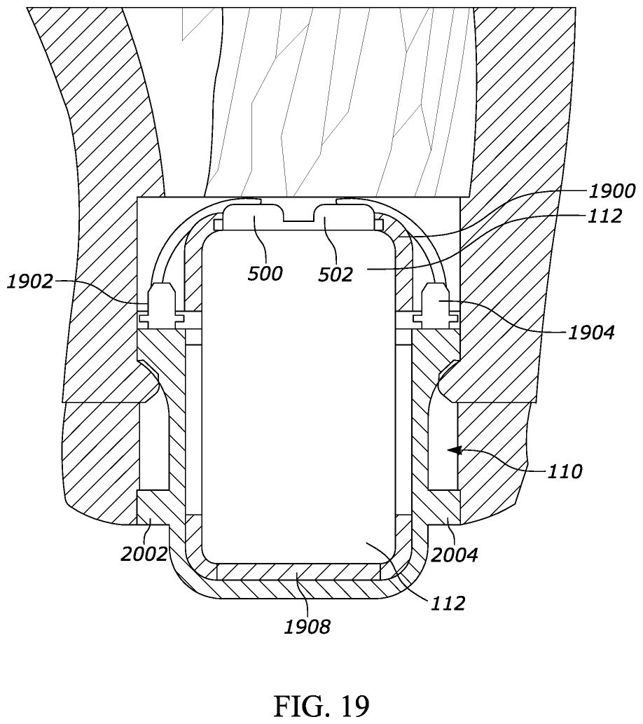

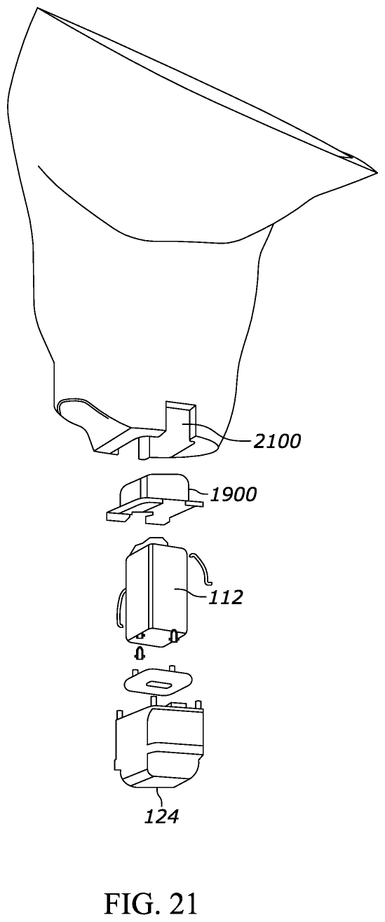

In some implementations, the acoustic transducer assembly optionally comprises an extraction feature enabling the acoustic transducer assembly to be mechanically and electrically decoupled from the housing. In FIG. 1, a plate forms a flange at the end of the transducer assembly that can be used to extract the transducer assembly from the device housing, such as by using a pinching tool that grabs a surface of the flange to pull the transducer assembly from the device housing. In FIGS. 4, 8, 10, 13, 16 and 19, the extraction features include plate recesses, a keyed portion of a plate, secondary housing recesses and secondary housing flanges, for engagement with an extraction tool to pull the transducer assembly from the device housing. In FIGS. 17-18, keying features can be added to the plate to enable engagement by an extraction tool 1700. In FIG. 18, 90 degree rotation of the extraction tool causes tabs on the tool to engage an inside surface of the plate, thereby enabling removal of the transducer assembly. In FIGS. 19-21, a secondary housing portion 513 includes extraction features such as flanges 2002 and 2004 on an outer surface thereof. The flanges are grippable by an extraction tool. Recesses 2100 in the end portion of the ear-worn device housing allow access to the flanges by the extraction tool.

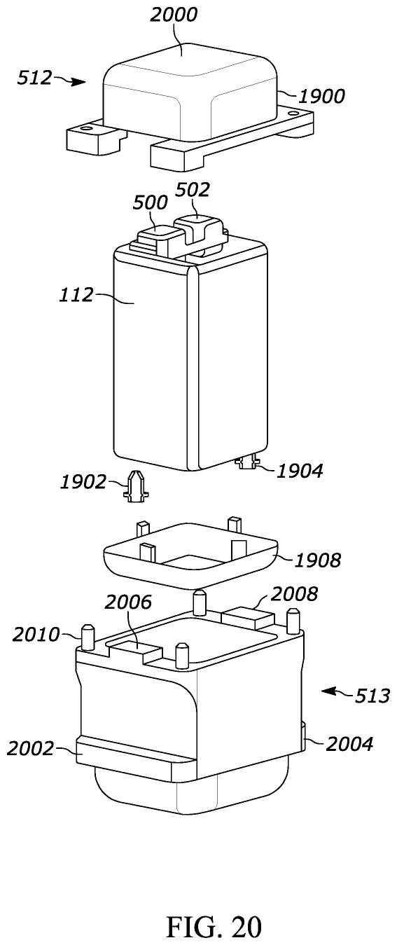

In some implementations, the acoustic transducer is mechanically coupled to a support structure having an opening and an open portion of the transducer is aligned with and acoustically coupled to the opening of the support structure. In FIG. 1, a support structure 122 includes a plate mechanically affixed, such as by glue or other suitable mechanism, to an end of the acoustic transducer. The support structure can also be a portion of a secondary housing as shown in FIGS. 4 and 20, or a secondary housing portion.

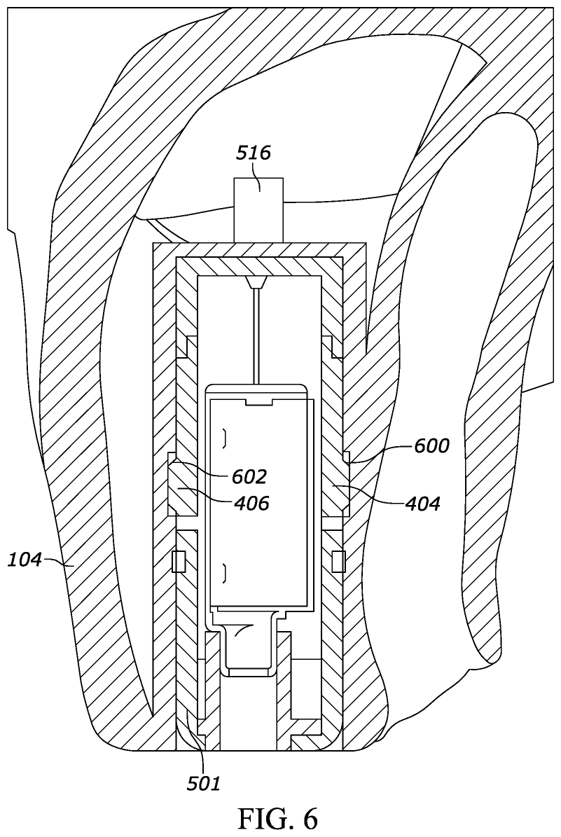

In FIGS. 4-7, a shell customized for the user's anatomy serves as the housing of the ear-worn device housing. In FIG. 4, an opening 106 in an end portion of the housing defines a cavity sized to receive the acoustic transducer assembly. In FIG. 6, recesses 600 and 602 in the cavity receive corresponding spring fingers 404 and 406 on the acoustic transducer assembly 110 to provide a releasable snap feature that retains the transducer assembly in the cavity. The acoustic transducer assembly can be removed from the end portion 102 of the housing for service or replacement by flexing the spring fingers. In FIG. 4, the end portion 102 includes extraction recesses 406 near a front of the acoustic transducer for an extraction tool to grab and extract the acoustic transducer assembly from the end portion. In FIG. 6, a vent tube 401 can be provided to equalize ambient pressure if necessary.

In FIGS. 4-7, the acoustic transducer assembly 110 includes an acoustic transducer 112 (not shown in FIG. 4) isolation mounted within a secondary isolation housing 400, such as a plastic housing. In FIG. 5, acoustic transducer electrical terminals or contacts 500 and 502 are located on an outside end surface of the acoustic transducer and are electrically connected through loose litz wires 504 and 506 to connector pins 508 and 510 secured to an end cap 512 of the secondary housing 400. The litz wires add small amount stiffness and mechanical coupling between the connector pins and the acoustic transducer. The wires 504 and 506 are compliant electrical wires that electrically couple the acoustic transducer to the ear-worn hearing device and can provide some vibration isolation. The end cap 512 is affixed to a secondary housing portion 513 via glue, snap fit or other suitable attachment mechanism. The connector pins 508 and 510 are part of an electrical connector assembly and are releasably connected to corresponding electrical sockets 516 and 518 in the housing of the ear-worn hearing device. In this example, the connector pins 508 and 510 include protruding portions that can disengage mechanically and electrically from the electrical sockets in response to a pulling force on the acoustic transducer assembly.

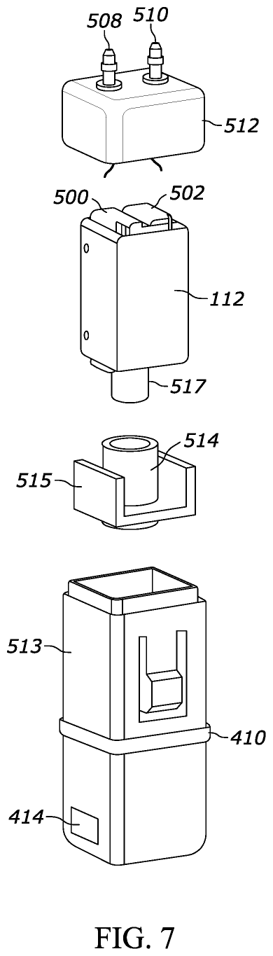

In FIG. 7, a vibration isolator comprises a resilient tube member 514 that isolates the acoustic transducer from vibration. The resilient tube member 514 receives a nozzle 517 from the acoustic transducer 112. The nozzle 517 acoustically couples with the open portion from which sound is emitted. Flaps 515 from the tube member 514 cover the grab holes 414, 416 (also shown in FIG. 5) to avoid wax and debris ingress to the acoustic transducer housing. A elastic ring 410, or gasket, around the isolation housing prevents wax and debris from contaminating the electrical contacts 508, 510 and can provide some vibration isolation. In FIG. 6, spring fingers 404 and 406 in the isolation housing releasably retain the transducer assembly in the ear-worn hearing device housing (e.g., ITE shell).

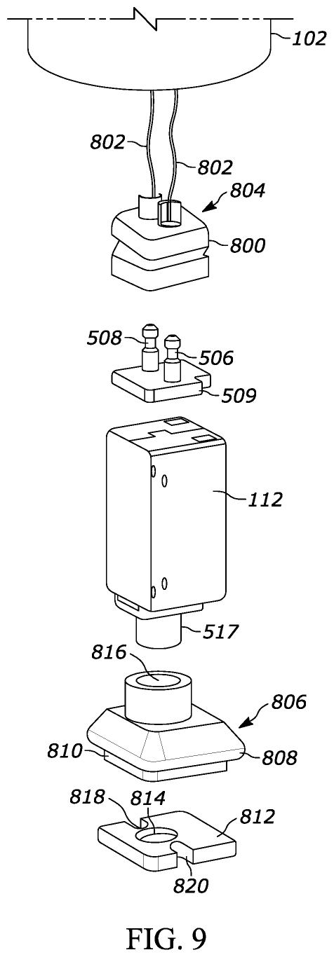

In FIG. 5, the extraction feature comprises rectangular grab holes 414 and 416 located in sidewalls of the secondary housing at an end that includes the sound opening. The grab holes are configured to receive an extraction tool used to grab and pull the acoustic transducer assembly from the cavity of the ear-worn hearing device housing for repair or replacement. In FIGS. 8-9, the extraction feature comprises a recess 818 and 820 on a plate 812 of the transducer assembly.

In FIG. 5, the secondary housing portion 513 contains the acoustic transducer and the vibration isolator. The support structure comprises an end of the secondary housing defining the opening, and the vibration isolator comprises an elastic boot comprising a passage coupling the open portion of the acoustic transducer to opening of the secondary housing. In FIG. 6, the retention structure comprises a flexible member, such as spring finger 404, on the secondary housing, wherein the flexible member is engageable with a portion of the ear-worn hearing device housing when the transducer assembly is assembled therewith.

Referring to FIGS. 8-9, a transducer assembly devoid of a secondary housing comprises a terminal 509 with pin contacts 506, 508. The terminal is fastened to the acoustic transducer 112 and the pin contacts are releasably connectable to connector sockets 804 of a connector 800. The connector sockets 804 are connected to the electrical circuit by wires 802. Extra wiring 802 allows removal of the connector 800 and transducer assembly from inside the end portion so that the connector can be held and separated from the acoustic transducer.

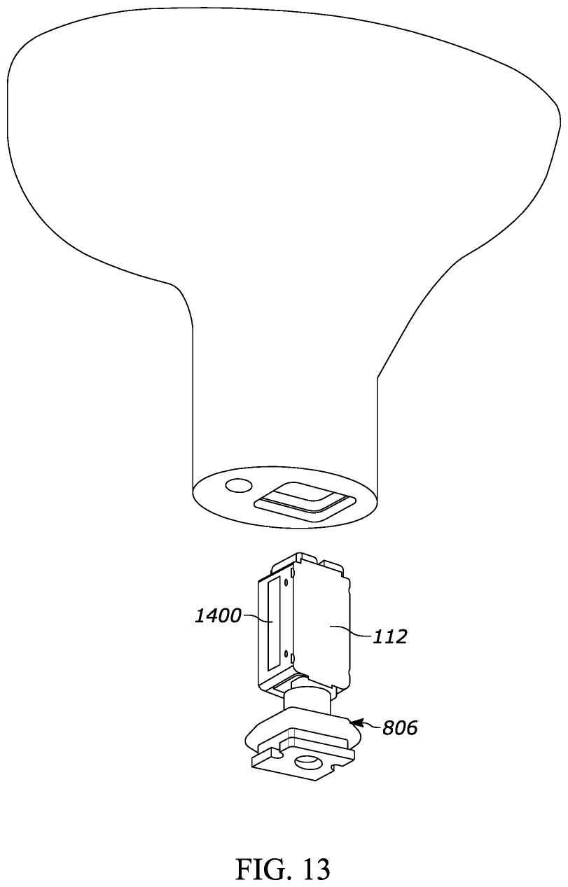

In FIGS. 8 and 9, the removable transducer assembly includes an elastic isolation structure, such as an elastic boot 806. The isolation structure includes a retention structure configured as a barbed portion 808 that engages with a lip 1500 in the end portion of the housing as described further herein in connection with FIGS. 13-15. A sealing surface 810, in this example a rectangular shaped sealing surface, seals an end of the transducer assembly in the opening of the housing. The acoustic transducer comprises a support structure in the form of a plate 812 defining an opening that acoustically couples to the opening 116 of the elastic boot 806. The elastic boot comprises a passage 816 coupling the sound port of the acoustic transducer to the opening 814 of the plate. The elastic boot may be glued to the plate, insert molded or attached in any suitable manner.

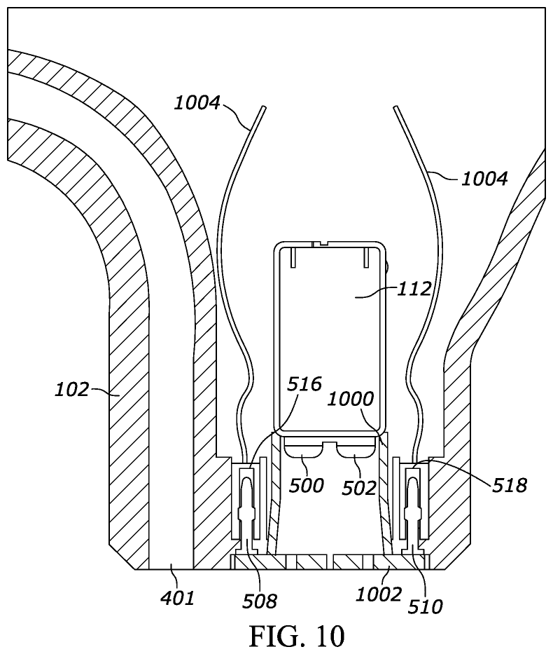

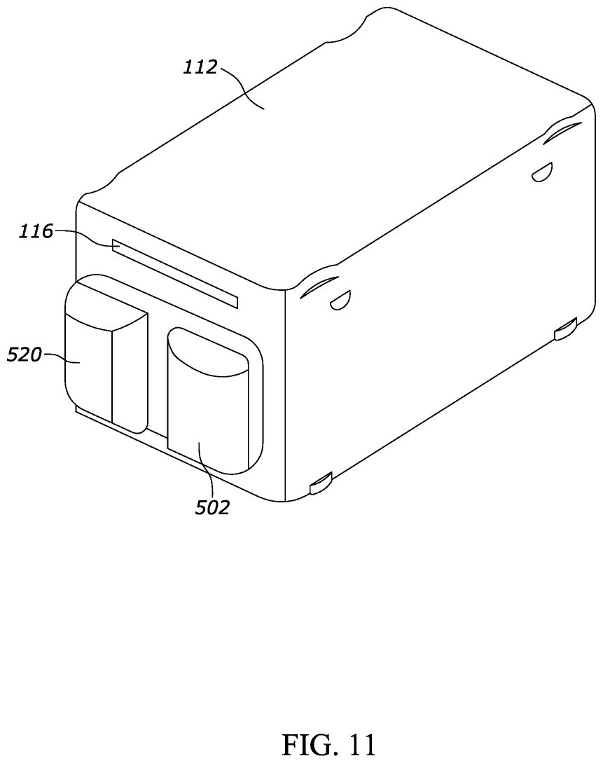

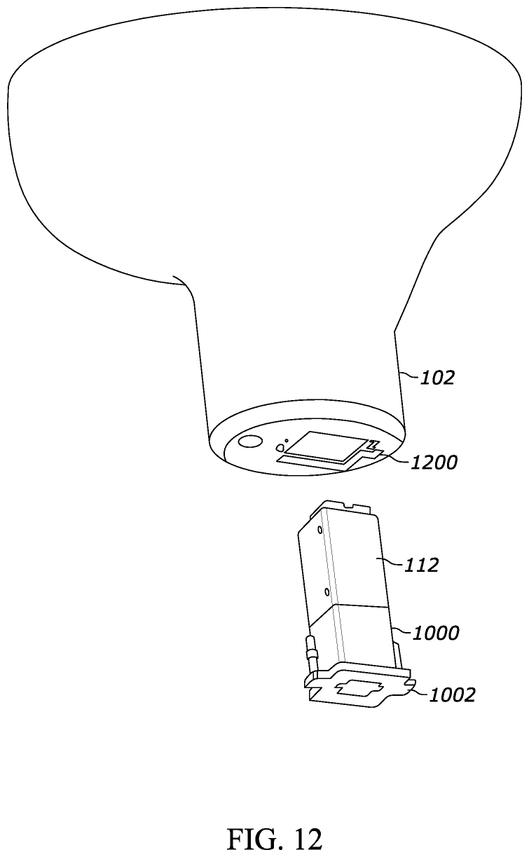

In FIGS. 10-12, a front mount acoustic transducer in an elastic boot is shown. In FIG. 11, the acoustic transducer 112 has a sound port opening 116 on a same end as electrical terminals 500 and 502. In FIGS. 10 and 12, an elastic boot 1000 is coupled to the end of the acoustic transducer with the terminals. A plate 1002 with flanges for supporting connector pins and a keyed opening is coupled to the elastic boot 1000. The boot and acoustic transducer may be glued, over molded or affixed in any suitable manner. The boot is integrated with the plate and includes a base that serves as a wax guard and acoustic seal. The plate 1002 may be a printed circuited board with metal traces and solder pads connectable to contacts of the transducer by wires. The plate 1000 also supports connector pins 508 and 510 electrically connected to corresponding solder pads by conductive traces on the plate. Sockets 516 and 518 in the end portion of the housing are removably connectable with the contact pins 508, 510 when the transducer assembly is inserted in the cavity of the housing. Wires 1004, such as litz wires, connect the sockets to the electrical circuitry 108. A vibration isolation structure configured as a boot 1000 is located between the front flange 1002 and the acoustic transducer. The boot has a seal to the ear-worn device housing, in this case a radial seal. Retention in this example is provided by over-center and/or friction features in the socket-pin interface. Recesses 1200 in the end portion of the housing receive the flanges that support the connector pins.

In FIGS. 13-15, the acoustic transducer assembly comprises an elastic boot and support structure similar to that shown in FIGS. 8 and 9, wherein the acoustic transducer is electrically connected to the electric circuit through spring finger contacts 1502 and 1504 that are fixedly attached to the ear-worn device housing. The transducer comprises electrical contact strips 1400 and 1402 positioned on sides of the acoustic transducer and connected to contacts 500 and 502 on a terminal of the transducer. In some implementations, the transducer coil can be connected to the strips 1400 and 1402 by a flex circuit or other conductors without and the contacts 500 and 502 can be eliminated. The electrical contact strips can be metal on printed circuit boards or flex strips glued to the sides of the acoustic transducer. The terminals 500 and 502 are electrically connected to the contact strips. The spring fingers 1502, 1504 are releasably engaged with the contact strips 500, 502 of the acoustic transducer and can provide come vibration isolation.

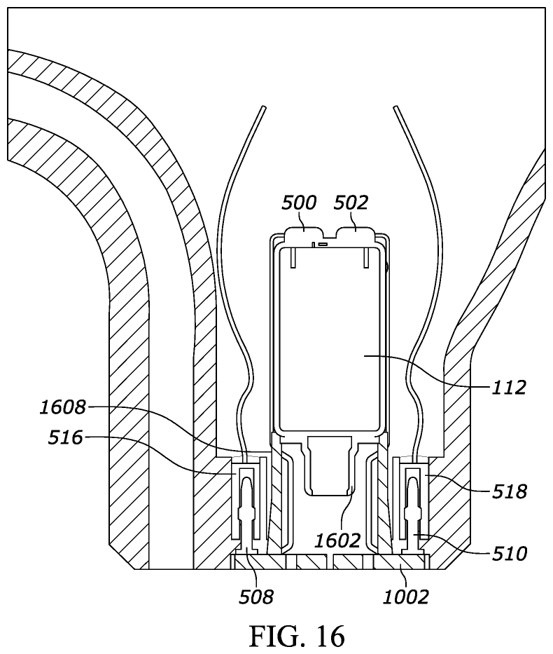

In FIGS. 16-18, wires connected to terminal contacts 500, 502 of the acoustic transducer pass through one or more openings of the elastic boot and transition to inside the boot to save space. The boot includes a cylindrical opening to receive the transducer nozzle 1602. The wires can be soldered to pad on the plate and coupled to the pins 508, 510 via traces on the plate, as described in connection with FIGS. 10-12.

In FIGS. 19-21, in some implementations, the acoustic transducer assembly has terminals 500 and 502 coupled to the electrical circuit via contact spring connector pins (not shown) or other contact surfaces in the ear-worn device housing to connect to the electrical circuit. In this example the support structure includes the end cap 512 that also provides vibration isolation and includes a second elastic boot 1900 coupled to a second end, opposite the first end, of the acoustic transducer. The second elastic boot 1900 comprises a terminal pass through opening 2000 sized to allow the terminals 500 and 502 to pass thought the elastic boot. The pass through allows the terminals to be electrically connected to contacts in the ear-worn device. The electrical wires are directly connected to the terminals of the acoustic transducer and are electrically connected to each of the pins 1902 and 1904.

In FIGS. 19-21, a vibration isolation structure configured as an elastic cup 1908 is attached to a front end of the acoustic transducer 112 and seats inside a base portion of the secondary housing portion 513. The secondary housing portion 513 includes pin support portions 2006 and 2008 where the pins are mounted. Alignment projections 2010 align with openings in the end cap 1900 to provide vibration isolation. Pins 2010 align the housing portion 513 with housing portion 512.

As disclosed and illustrated, in some examples, an acoustic transducer support structure employs a full housing and/or support plate. In some examples a vibration isolation system employs one or more of an elastic boot, housing boot, spring fingers, litz wiring, and/or elastic gaskets attached to an outside of an isolation housing. In some examples, speaker retention structures that provide acoustic transducer assembly removal include one or more of spring fingers, connector pin and socket configurations, barbed structures on vibration isolation structures, and retention protrusions on acoustic transducer housings that interact with ear-worn device housing cavities. In some examples, electrical connections with the acoustic transducer allow disconnection via one or more pins that are affixed to the isolation housing, spring finger engagement with contacts on sides of the transducer housing, removable connectors with litz wires connections electrically connectable to terminal contacts on an end of the transducer, disconnectable electrical pins that are affixed to a plate, and disconnectable electrical pins that are affixed to terminals of the acoustic transducer.

In some embodiments, extraction structures to remove the transducer assembly from the cavity in the end portion of the ear-worn device housing include one or more of isolation housing recesses, support plate recesses, keyed plates and support plates with removal flanges. In some implementations, wax and/or debris barriers for electrical contacts include one or more of a gasket around an exterior of an isolation housing, around an exterior of a transducer housing, a seal between a vibration isolation structure and a transducer housing. In some implementations, wax and/or debris barriers for a speaker include a flange to cover grab holes in the isolation housing. However, it will be recognized that any suitable structures and combinations may be employed.

While the disclosure and what is presently considered to be the best mode thereof has been described in a manner establishing possession and enabling those of ordinary skill in the art to make and use the same, it will be understood and appreciated that there are many equivalents to the representative embodiments described herein and that myriad modifications and variations may be made thereto without departing from the scope and spirit of the invention, which is to be limited not by the embodiments described but by the appended claims and their equivalents.

What is claimed is:

1. An ear-worn hearing device comprising:
a housing comprising an end portion configured for at least partial insertion into a user's ear, the housing comprising an opening at the end portion;
an electrical circuit disposed in the housing; and
a transducer assembly disposed in the housing, the transducer assembly comprising:
an acoustic transducer comprising a motor-actuated diaphragm and an open portion from which sound is emitted;
electrical contacts removably coupled electrically to corresponding contacts of the electrical circuit; and
a retention structure removably coupled mechanically to the housing.

2. The ear-worn hearing device of claim 1 further comprising a support structure mechanically coupled to the acoustic transducer, wherein the open portion of the acoustic transducer is acoustically coupled with an opening of the support structure.

3. The ear-worn hearing device of claim 2 further comprising a vibration isolator coupling the acoustic transducer to the support structure.

4. The ear-worn assembly of claim 3, the vibration isolator comprising a compliant electrical connection.

5. The ear-worn assembly of claim 3, the support structure comprising a plate defining the opening, and the vibration isolator comprising a first elastic boot comprising a passage coupling the open portion of the acoustic transducer to opening of the plate.

6. The ear-worn assembly of claim 5, the retention structure comprising an elastic barb on the vibration isolator, wherein the elastic barb is engageable with a portion of the housing when the transducer assembly is assembled with the housing.

7. The ear-worn assembly of claim 3, the vibration isolator further comprising an elastic boot coupled to a second end, opposite the first end, of the housing.

8. The ear-worn assembly of claim 3, the vibration isolator further comprising compliant electrical wires that electrically couple the acoustic transducer to the housing, the electrical wires coupled to a first side of an electrical connector assembly and the acoustic transducer coupled a second side of the electrical connector assembly, wherein the electrical connector assembly is removably connectable from the acoustic transducer.

9. The ear-worn assembly of claim 9, the electrical wires comprising spring fingers releasably coupled to the acoustic transducer.

10. The ear-worn assembly of claim 3 further comprising a secondary housing portion containing the acoustic transducer and the vibration isolator, the support structure comprising an end of the secondary housing defining the opening, and the vibration isolator comprising an elastic boot comprising a passage coupling the open portion of the acoustic transducer to the opening of the secondary housing.

11. The ear-worn assembly of claim 10, the retention structure comprising a flexible member on the secondary housing, wherein the flexible member is engageable with a portion of the housing when the transducer assembly is assembled with the ear-worn hearing device.

12. The ear-worn assembly of claim 11 further comprising a gasket disposed between the acoustic transducer and a portion of the secondary housing, wherein the gasket forms a debris barrier when the transducer assembly is assembled with the housing.

13. A transducer assembly configured for removable assembly with an ear-worn hearing device housing that extends at least partially into a user's ear, the transducer assembly comprising:
an acoustic transducer comprising a motor-actuated diaphragm and an open portion from which sound is emitted;
a support structure mechanically coupled to the acoustic transducer, the open portion of the acoustic transducer acoustically coupled with an opening of the support structure; and
a retention structure configured to retain the transducer assembly in a cavity of an ear-worn hearing device housing when the transducer assembly is assembled with the ear-worn hearing device housing.

14. The transducer assembly of claim 13 further comprising a vibration isolator coupling the acoustic transducer to the support structure, and an extraction feature on the support structure, wherein the transducer assembly can be removed from the ear-worn hearing device housing via the extraction feature.

15. The transducer assembly of claim 14, the vibration isolator comprising a compliant electrical connection comprising spring fingers that are releasably coupled to the acoustic transducer.

16. The transducer assembly of claim 14, the acoustic transducer comprising a housing defining the open portion on a first end, the support structure comprising a plate defining the opening, and the vibration isolator comprising a first elastic boot comprising a passage coupling the open portion of the acoustic transducer to the opening of the plate.

17. The transducer assembly of claim 16, the retention structure comprising an elastic barb on the vibration isolator, wherein the elastic barb is engageable with a portion of the ear-worn hearing device housing when the transducer assembly is assembled with the ear-worn hearing device housing.

18. The transducer assembly of claim 17, the vibration isolator further comprising a second elastic boot coupled to a second end, opposite the first end, of the housing, the second elastic boot comprising a contact electrically connected to a contact on a terminal of the acoustic transducer.

19. The transducer assembly of claim 14 further comprising a secondary housing portion containing the acoustic transducer and the vibration isolator, the support structure comprising an end of the secondary housing defining the opening, and the vibration isolator comprising an elastic boot comprising a passage coupling the open portion of the acoustic transducer to opening of the secondary housing.

20. The transducer assembly of claim 19, the retention structure comprising a flexible member on the secondary housing, wherein the flexible member is engageable with a portion of the ear-worn hearing device housing when the transducer assembly is assembled with the ear-worn hearing device.

21. The transducer assembly of claim 20 further comprising a gasket disposed between the acoustic transducer and a portion of the secondary housing, wherein the gasket forms a debris barrier when the transducer assembly is assembled with the ear-worn hearing device housing.
